(19) United States
(12) Patent Application Publication
(10) Pub. No.: US 2013/0254128 A1
(43) Pub. Date: Sep. 26, 2013

(54) METHOD FOR DETECTING AND EXHIBITING INFRINGEMENTS OF REGULATIONS AND BREACHES OF RULES

(71) Applicant: Schweers Informationstechnologie GmbH, (US)

(72) Inventor: Michael SCHWEERS, Meerbusch (DE)

(73) Assignee: Schweers Informationstechnologie GmbH, Meerbusch (DE)

(21) Appl. No.: 13/849,802

(22) Filed: Mar. 25, 2013

(30) Foreign Application Priority Data
Mar. 26, 2012 (EP) 12161350.9-2221

(51) Int. Cl. G06Q 30/00

(52) U.S. Cl. CPC G06Q 30/018
USPC 705/317

(57) ABSTRACT

Method for detecting and exhibiting infringements of regulations and breaches of rules, wherein the latter are detected by means of a hand-held computer, wherein the infringement of regulations or the breach of rules is established by an inspector and is input by said inspector into the hand-held computer, and a printed notification, relating to the infringement of regulations or the breach of rules, is handed over or left behind.

### CROSS-REFERENCE TO RELATED APPLICATIONS AND CLAIM TO PRIORITY

This application is related to application number 12161350.9-2221, filed Mar. 26, 2012, in the European Patent Office, the disclosure of which is incorporated by reference and to which priority is claimed.

### FIELD OF THE INVENTION

The invention relates to a method for detecting and exhibiting infringements of regulations and breaches of rules, particularly by parked articles, such as vehicles, dustbins or the like, wherein an infringement of regulations and a breach of rules are detected by means of a hand-held computer, wherein the infringement of regulations or the breach of rules is established by an inspector and is input by said inspector into the hand-held computer, and a printed notification, for example in the form of a printed card, a printed slip or a printed sticker, relating to the infringement of regulations or the breach of rules is handed over or left behind.

### BACKGROUND OF THE INVENTION

The invention also relates to a system for detecting and exhibiting infringements of regulations and breaches of rules, particularly by parked articles, such as vehicles, dustbins or the like, wherein the system comprises a hand-held computer for detecting an infringement of regulations or a breach of rules and also, for each infringement of regulations or breach of rules, a printed notification, for example in the form of a printed card, a printed slip or a printed sticker, which can be attached to the article. This system can be used particularly for carrying out the method according to the invention.

It is known practice to use mobile data capture systems in the form of hand-held computers for detecting infringements of regulations. A wide variety of appliances are available for this and can be used to manually or electronically capture data pertaining to an infringement of regulations or a breach of rules in situ. The data are then stored in the hand-held computer and the charge is handed over by means of a printed notification or is left behind on an article, such as a vehicle.

Leaving behind the specific charge is prescribed by law in most countries. In Germany, furthermore, there is the option of—instead of a specific charge—leaving behind or handing over just advice of an infringement of regulations which is not specified in more detail or a breach of rules which is not specified in more detail.

In such cases, the advice states that an infringement of regulations has been established as part of an automated process and that shortly an appropriate notice will be issued to the relevant authorities.

A drawback in this context is that a mobile printer is required in order to leave behind the notification about the charge. This means additional weight for the inspector, and a high level of expenditure as a result of special paper, which is usually pre-printed and hence particularly costly. Frequently the printing is also done on a plastic material with a thermal coating, which is not environmentally friendly. In addition, mobile printers are expensive to purchase and maintain and are furthermore frequently susceptible to technical faults.

### SUMMARY OF THE INVENTION

It is an object of the invention to avoid the aforementioned drawbacks and to specify a method of the generic type and a system of the generic type which can be easily and inexpensively used to make a notification about a detailed charge available to the recipient of the infringement of regulations.

### DETAILED DESCRIPTION OF THE PREFERRED EMBODIMENT(S)

This object is achieved in that the notification is provided with a prefabricated, in particular pre-printed, explicit identification and the inspector produces a link between the infringement of regulations which said inspector has input into the hand-held computer and the identification and then feeds the detected infringement of regulations, linked to the identification, in real time from the hand-held computer via a communication network to a central data location, from which the infringement of regulations can be read via a communication network by using the identification, for example by an owner of the article or user of the vehicle. Hence, a suitable access appliance, for example a computer with Internet access, can easily be used to view the detailed charge about the infringement of regulations.

Preferably, various templates for different infringements of regulations or breaches of rules may be stored in the hand-held computer and, according to the specific situation, are selected by the inspector in the hand-held computer and may be linked to one of the prefabricated, in particular pre-printed, explicit identifications, with the result that, by way of example, prefabricated cards provided with various explicit identifications are carried and are linked in situ to the detected infringement of regulations or the detected breach of rules.

According to the invention, an infringement of regulations or a breach of rules may be linked to an identification in the hand-held computer manually and/or by means of electronic reading. By way of example, it is thus possible for a coding provided as an identification, particularly in the form of a barcode or QR code or else an RFID transponder, to be provided on the identification.

In one preferred exemplary embodiment of the invention, the detected infringement of regulations or the detected breach of rules may be fed from the hand-held computer via a communication network to a central data location automatically after it has been linked to an identification, with the result that no further activity by the inspector in this regard is required and the feed cannot also be forgotten.

According to the invention, the notification may be printed by the inspector in situ after an infringement of regulations or a breach of rules has been linked to an identification in the hand-held computer.

It is also possible for the notification to be printed by the inspector even before an infringement of regulations or a breach of rules has been detected, and the inspector can carry a number of notifications which are each provided with different identifications. This avoids the drawbacks of a mobile printer which were described at the outset.

The object on which the invention is based is also achieved by virtue of a system of the generic type also comprising a communication network, and the notification being provided with a prefabricated, in particular pre-printed, explicit identification, and by virtue of the hand-held computer having an input device which an inspector uses to produce a link between the infringement of regulations or the breach of rules which said inspector has detected using the hand-held computer and the identification, and by virtue of the hand-held computer also comprising a transmission device for feeding the detected infringement of regulations or breach of rules, linked to the identification, in real time via a communication network to a central data location, from which the infringement of regulations can be read via a communication network by using the identification, for example by an owner of the article or user of the vehicle.

According to the invention, the hand-held computer may be provided with various templates for different infringements of regulations or breaches of rules in the hand-held computer, from which templates, according to the specific situation, the appropriate template can be selected by the inspector and can be linked to one of the prefabricated, in particular pre-printed, explicit identifications.

Advantageously, the hand-held computer may be provided with an input apparatus for linking an infringement of regulations or a breach of rules to an identification in the hand-held computer and/or with a reading apparatus for electronic reading of the identification, which may be provided particularly in the form of a barcode or QR code or else an RFID transponder.

In one preferred exemplary embodiment of the invention the hand-held computer may be controlled such that the detected infringement of regulations or the detected breach of rules is fed from the hand-held computer via a communication network to a central data location automatically after it has been linked to an identification.

Advantageously, the system may also comprise a mobile printer, particularly integrated into the hand-held computer, for the inspector to print the notification in situ after an infringement of regulations or a breach of rules has been linked to an identification, particularly in the form of a barcode or QR code.

It is also possible for the notifications to be in the form of notifications which are pre-printed even before an infringement of regulations or a breach of rules has been detected and which are provided with respective different identifications, particularly in the form of a barcode or QR code or else an RFID transponder. Hence, the drawbacks of a mobile printer which were described at the outset are avoided.

I claim:

1. Method for detecting and exhibiting infringements of regulations and breaches of rules, particularly by parked articles, such as vehicles, dustbins or the like, wherein an infringement of regulations and a breach of rules are detected by means of a hand-held computer, wherein the infringement of regulations or the breach of rules is established by an inspector and is input by said inspector into the hand-held computer, and a printed notification, for example in the form of a printed card, a printed slip or a printed sticker, relating to the infringement of regulations or the breach of rules is handed over or left behind, characterized in that the notification is provided with a prefabricated, in particular pre-printed, explicit identification and the inspector produces a link between the infringement of regulations which said inspector has input into the hand-held computer and the identification and then feeds the detected infringement of regulations, linked to the identification, in real time from the hand-held computer via a communication network to a central data location, from which the infringement of regulations can be read via a communication network by using the identification, for example by an owner of the article or user of the vehicle.

2. Method according to claim 1, characterized in that various templates for different infringements of regulations or breaches of rules are stored in the hand-held computer and, according to the specific situation, are selected by the inspector in the hand-held computer and are linked to one of the prefabricated, in particular pre-printed, explicit identifications.

3. Method according to claim 1, characterized in that an infringement of regulations or a breach of rules is linked to an identification in the hand-held computer manually and/or by means of electronic reading.

4. Method according to claim 1, characterized in that the detected infringement of regulations or the detected breach of rules is fed from the hand-held computer via a communication network to a central data location automatically after it has been linked to an identification.

5. Method according to claim 1, characterized in that the notification is printed by the inspector in situ after an infringement of regulations or a breach of rules has been linked to an identification in the hand-held computer.

6. Method according to claim 1, characterized in that the notification is printed by the inspector even before an infringement of regulations or a breach of rules has been detected, and the inspector carries a number of notifications which are each provided with different identifications.

7. System for detecting and exhibiting infringements of regulations and breaches of rules, particularly by parked articles, such as vehicles, dustbins or the like, wherein the system comprises a hand-held computer for detecting an infringement of regulations or a breach of rules and also, for each infringement of regulations or breach of rules, a printed notification, for example in the form of a printed card, a printed slip or a printed sticker, which can be attached to the article, relating to the infringement of regulations or the breach of rules, particularly for carrying out the method according to one of the preceding claims, characterized in that the system also comprises a communication network, and the notification is provided with a prefabricated, in particular pre-printed, explicit identification, and in that the hand-held computer has an input device which an inspector uses to produce a link between the infringement of regulations or the breach of rules which said inspector has detected using the hand-held computer and the identification, and in that the hand-held computer also comprises a transmission device for feeding the detected infringement of regulations or breach of rules, linked to the identification, in real time via a communication network to a central data location, from which the infringement of regulations or the breach of rules can be read via a communication network by using the identification, for example by an owner of the article or user of the vehicle.

8. System according to claim 7, characterized in that the hand-held computer is provided with various templates for different infringements of regulations or breaches of rules in the hand-held computer, from which templates, according to the specific situation, the appropriate template can be selected by the inspector and can be linked to one of the prefabricated, in particular pre-printed, explicit identifications.

9. System according to claim 7, characterized in that the hand-held computer is provided with an input apparatus for linking an infringement of regulations or a breach of rules to an identification in the hand-held computer and/or with a reading apparatus for electronic reading of the identification.

10. System according to claim 7, characterized in that the hand-held computer is controlled such that the detected infringement of regulations or the detected breach of rules is fed from the hand-held computer via a communication network to a central data location automatically after it has been linked to an identification.

11. System according to claim 7, characterized in that the system also comprises a mobile printer, particularly integrated into the hand-held computer, for the inspector to print the notification in situ after an infringement of regulations or a breach of rules has been linked to an identification, particularly in the form of a barcode or QR code.

12. System according to claim 7, characterized in that the notifications are in the form of notifications which are pre-printed even before an infringement of regulations or a breach of rules has been detected and which are provided with respective different identifications, particularly in the form of a barcode or QR code or else an RFID transponder.
